(19) United States
(12) Patent Application Publication
(10) Pub. No.: US 2014/0197809 A1
(43) Pub. Date: Jul. 17, 2014

(54) SWITCHING REGULATOR INCLUDING CHARGE PUMP

(71) Applicants: Ching-Yu Chen, Guanxi Township (TW); Feng-Wei Lin, Bade City (TW); Kwang-Jae Kim, Gyeonggi-do (KR)

(72) Inventors: Ching-Yu Chen, Guanxi Township (TW); Feng-Wei Lin, Bade City (TW); Kwang-Jae Kim, Gyeonggi-do (KR)

(73) Assignee: RICHTEK TECHNOLOGY CORPORATION, Zhubei City (TW)

(21) Appl. No.: 14/151,403

(22) Filed: Jan. 9, 2014

Related U.S. Application Data
(60) Provisional application No. 61/751,542, filed on Jan. 11, 2013.

(51) Int. Cl. H02M 3/156

(52) U.S. Cl. CPC H02M 3/1563
USPC 323/271

(57) ABSTRACT

The present invention discloses a switching regulator. The switching regulator converts an input voltage to an output voltage. The switching regulator includes: a power stage circuit, which switches at least one power switch thereof according to a driving signal to convert the input voltage to the output voltage; and a control circuit, which is coupled to the power stage circuit, for generating the driving signal according to a feedback signal. The power stage circuit includes: an active circuit, which includes the power switch and at least one inductor, and is controlled by a driving signal to convert the input voltage to a middle voltage; and a passive circuit, which is coupled to the active circuit, and includes a charge pump for converting the middle voltage to the output voltage.

### CROSS REFERENCE

The present invention claims priority to U.S. 61/751,542, filed on Jan. 11, 2013.

### BACKGROUND OF THE INVENTION

1. Field of Invention

The present invention relates to a switching regulator including a charge pump; particularly, it relates to such switching regulator which is capable of operating with a power switch thereof having a lower withstand voltage.

2. Description of Related Art

FIG. 1 shows a schematic diagram of a typical switching regulator 100. As shown in FIG. 1, the switching regulator 100 includes a power stage circuit 110 and a control circuit 120. The control circuit 120 generates an operation signal GATE according to a feedback signal FB, which is related to an output voltage Vout, for operating a power switch M of the power stage circuit 110 to convert an input voltage Vin to the output voltage Vout. The power stage circuit 110 is a boost power stage circuit, which includes the power switch M, an inductor L, and a diode D. How the power stage circuit 110 operates to convert the input voltage Vin to the output voltage Vout is well known by those skilled in the art, so details thereof are omitted here.

The maximum voltage level that a power switch can withstand is referred to as “withstand voltage”. The power switch M in the power stage circuit 110 is required to withstand a voltage as high as the output voltage Vout, i.e., when the switching regulator 100 operates, the power switch M needs to withstand the maximum level of the output voltage Vout, and the higher the output voltage Vout is, the higher the power switch is required to withstand. However, in the prior art switching regulator 100, when the withstand voltage (the voltage withstanding capability) of the power switch M is increased, i.e., when a power switch with a higher withstand voltage is used, the power conversion efficiency of the switching regulator 100 is reduced. Besides, when the output voltage Vout is high, the inductor current of the power stage circuit 110 is high, and an audio noise may be generated.

In view of above, to overcome the drawbacks in the prior art shown in FIG. 1, the present invention proposes a switching regulator which is capable of operating with a power switch thereof having a lower withstand voltage, wherein the switching loss of the power switch is also reduced, such that the power conversion efficiency is increased, and the audio noise is avoided.

### SUMMARY OF THE INVENTION

From one perspective, the present invention provides a switching regulator, for converting an input voltage to an output voltage, the switching regulator including: a power stage circuit, for switching at least one power switch thereof according to a driving signal to convert the input voltage to the output voltage, the power stage circuit including: an active circuit, which includes the power switch and an inductor, the active circuit being controlled by the driving signal to convert the input voltage to a middle voltage; and a passive circuit, which is coupled to the active circuit, and includes a charge pump for converting the middle voltage to the output voltage, wherein the charge pump consists of one or more passive devices without any active device; and a control circuit, which is coupled to the power stage circuit, for generating the driving signal according to a feedback signal.

In one preferable embodiment, the charge pump includes: a capacitor, which has one end coupled to a node between the power switch and the inductor; a first diode, which has a first forward terminal coupled to another end of the capacitor, and a first reverse terminal coupled to the output voltage; and a second diode, which has a second forward terminal for receiving a voltage, and a second reverse terminal coupled to the another end of the capacitor, wherein the voltage is the input voltage or another voltage.

In the aforementioned embodiment, the active circuit and the first diode of the charge pump preferably form a boost power conversion circuit.

In one preferable embodiment, the passive circuit is for receiving a predetermined voltage which is the input voltage or a voltage lower than the input voltage.

From another perspective, the present invention provides a switching regulator, for converting an input voltage to an output voltage, a power stage circuit, for switching at least one power switch thereof according to a driving signal to convert the input voltage to the output voltage, the power stage circuit including: an active circuit, which includes the power switch, an inductor, and a first diode, the active circuit being controlled by the driving signal to convert the input voltage to a middle voltage, wherein the power switch, the inductor, and the first diode are coupled to a common node; and a passive circuit, which is coupled to the active circuit, and includes a charge pump for converting the middle voltage to the output voltage, wherein the charge pump and the active circuit share the first diode; and a control circuit, which is coupled to the power stage circuit, for generating the driving signal according to a feedback signal.

In one preferable embodiment, the charge pump consists of one or more passive devices without any active device.

In one preferable embodiment, the charge pump includes: a capacitor, which has one end coupled to a node between the power switch and the inductor; the first diode, which has a first forward terminal coupled to another end of the capacitor, and a first reverse terminal coupled to the output voltage; and a second diode, which has a second forward terminal for receiving a voltage, and a second reverse terminal coupled to the another end of the capacitor, wherein the voltage is the input voltage or another voltage.

In one preferable embodiment, the active circuit is a boost power conversion circuit.

In one preferable embodiment, the passive circuit is for receiving a predetermined voltage which is the input voltage or a voltage lower than the input voltage.

The objectives, technical details, features, and effects of the present invention will be better understood with regard to the detailed description of the embodiments below.

### BRIEF DESCRIPTION OF THE DRAWINGS

FIG. 1 shows a schematic diagram of a typical switching regulator 100.

FIG. 2 shows a first embodiment of the present invention.

FIGS. 3A-3J show synchronous and asynchronous buck, boost, inverting, buck-boost, and inverting-boost power stage circuits.

FIG. 4 shows a second embodiment of the present invention.

FIG. 5 shows a third embodiment of the present invention.

FIGS. 6A-6G show advantages of the present invention over the prior art by illustrative examples.

FIGS. 7A-7B show a comparison of conversion and switching losses between the prior art and the present invention.

FIGS. 8A-8B show other embodiments of the passive circuit of the present invention.

### DESCRIPTION OF THE PREFERRED EMBODIMENTS

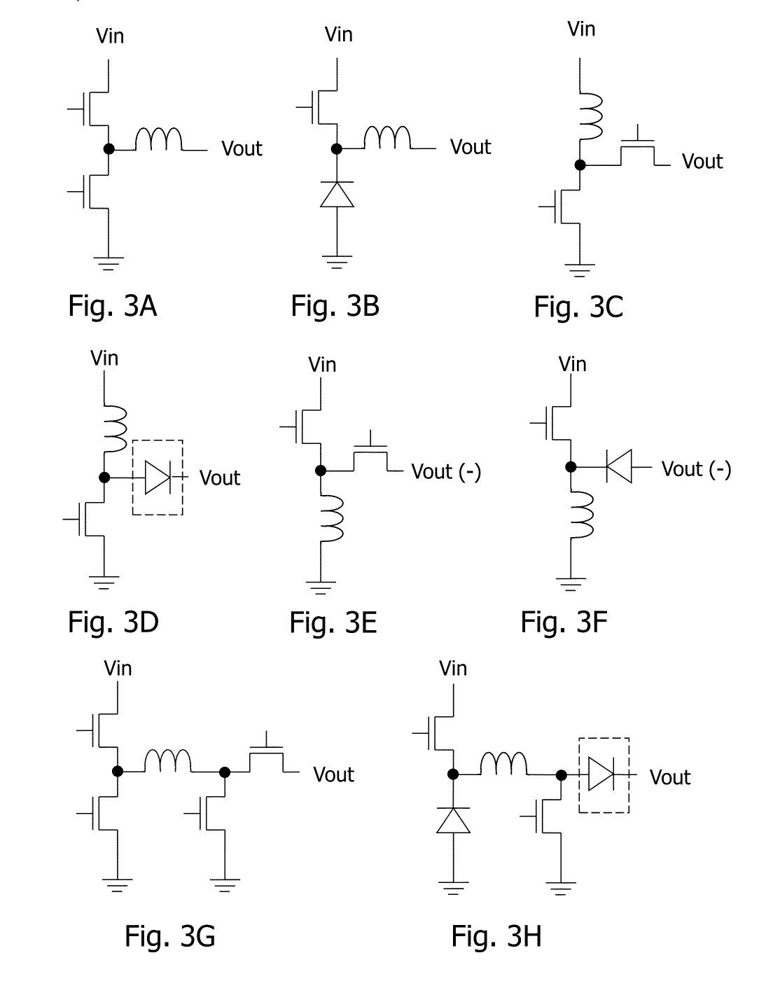

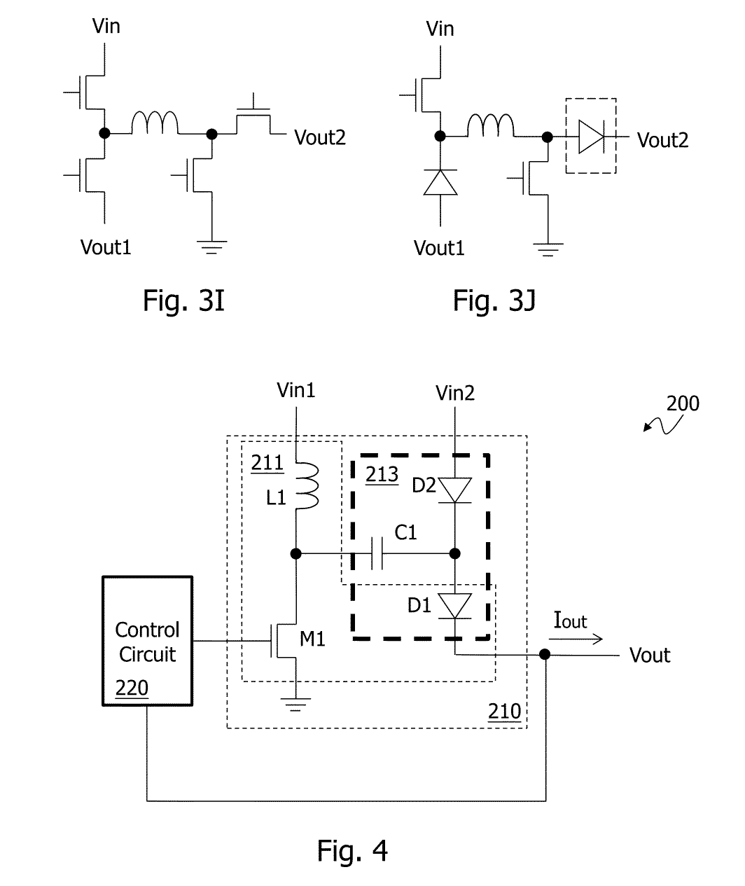

FIG. 2A shows a first embodiment of the present invention. As shown in FIG. 2A, a switching regulator 200 includes a power stage circuit 210 and a control circuit 220. The power stage circuit 210 switches a power switch M according to a driving signal GATE to convert an input voltage to an output voltage Vout. The control circuit 220 is coupled to the power stage circuit 210, and generates the driving signal GATE according a feedback signal. The power stage circuit 210 includes an active circuit 211 and a passive circuit 213. The active circuit 211 includes the power switch M and an inductor (not shown, to be described in detail later). The active circuit 211 is for receiving the input voltage Vin and the driving signal GATE to convert the input voltage Vin to a middle voltage. The passive circuit 213 is coupled to the active circuit 211, and includes a charge pump (not shown, to be described in detail later) to convert the middle voltage to the output voltage Vout. The active circuit 211 is for example but not limited to a synchronous and asynchronous buck, boost, inverting, buck-boost, or inverting-boost power stage circuit as shown in FIGS. 3A-3J.

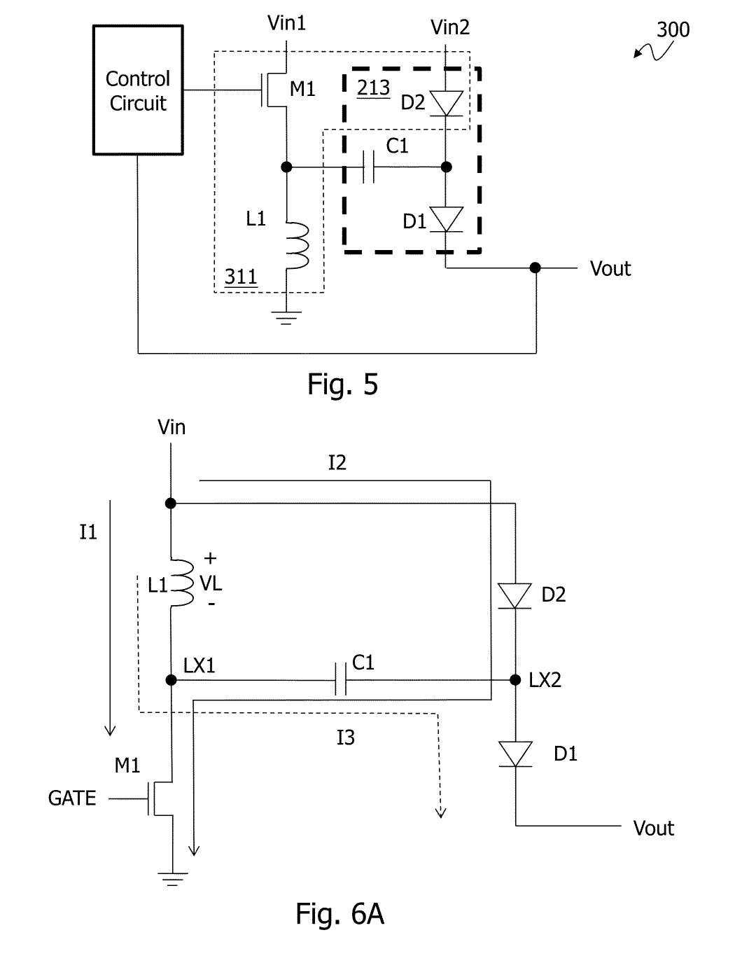

FIG. 4 shows a second embodiment of the present invention. This embodiment shows a more specific structure of the switching regulator 200 according to the present invention. As shown in the figure, the active circuit 211 includes the aforementioned boost power stage circuit, which includes the power switch M1, an inductor L1, and a diode D1. The passive circuit 213 includes a capacitor C1 and diodes D1 and D2, wherein the capacitor C1 and the diodes D1 and D2 form the charge pump, i.e., the charge pump includes the capacitor C1, and the diodes D1 and D2. The capacitor C1 has one end coupled to a node between the power switch M1 and the inductor L1. The diode D1 has a forward terminal coupled to the other end of the capacitor C1, and a reverse terminal coupled to the output voltage Vout. The diode D2 has a forward terminal for receiving a voltage, and a reverse terminal coupled to the other end of the capacitor C1, wherein the voltage may be the aforementioned input voltage Vin1 or another predetermined voltage Vin2. In the aforementioned arrangement, from one perspective, it may be considered as that the diode D1 is shared by the active circuit 211 and the passive circuit 213, i.e., the active circuit 211 includes the diode D1 and the passive circuit 213 also includes the diode D1, or from another perspective, it may be considered as that the active circuit 211 includes only the power switch M1 and the inductor L1 but not the diode D1, and the active circuit 211 together with the diode D1 form a complete power stage circuit. Referring to FIGS. 3D, 3H, and 3J, in these forms of power stage circuits, the active circuit 211 and the passive circuit 213 can share the diode, as indicated by dashed frames shown in the figures. The predetermined voltage Vin2 received by the passive circuit 213 may be the input voltage Vin1 itself or another voltage, for example but not limited to a voltage not higher than the input voltage Vin1. Or, the predetermined voltage Vin2 may have the same level as the input voltage Vin1 but from a different voltage supply source.

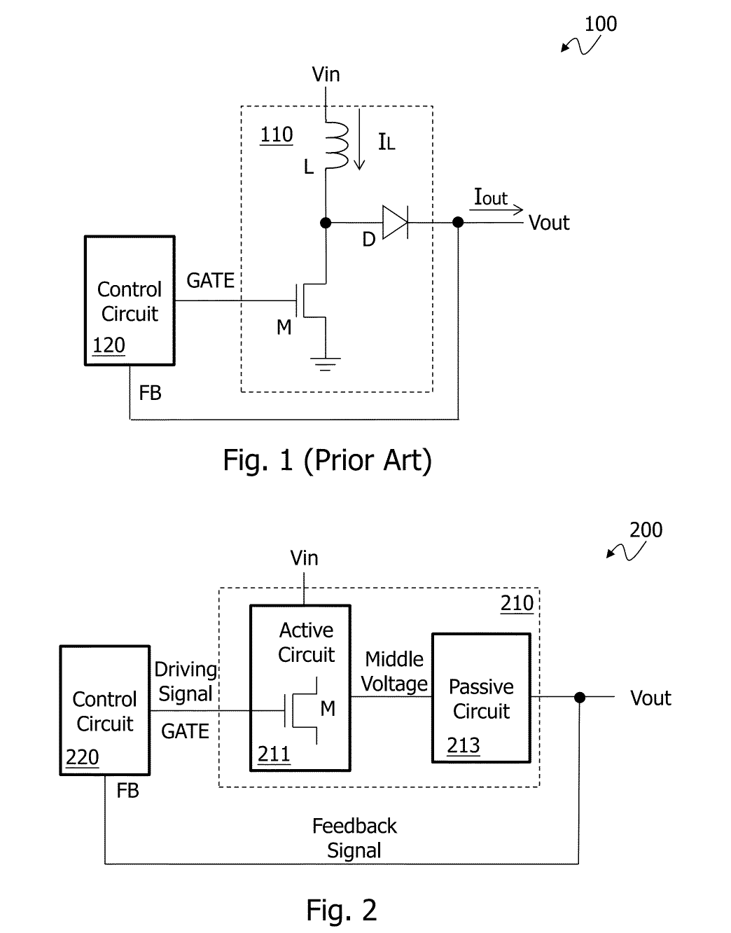

Compared with the prior art switching regulator 100 shown in FIG. 1, the switching regulator 200 shown in FIG. 4 according to the present invention can operate with a power switch M1 having a lower withstand voltage. More specifically, in the prior art, the withstand voltage of the power switch M of the switching regulator 100 is required to be as high as the output voltage Vout. On the other hand, in the present invention, the withstand voltage of the power switch M1 of the switching regulator 200 is required to be as high as the output voltage Vout minus the predetermined voltage Vin2 (Vout−Vin2), which is much lower. From another perspective, with a power switch having the same withstand voltage, the switching regulator according to the present invention can withstand a higher output voltage than the prior art switching regulator.

Besides, in the prior art switching regulator 100, the inductor current is:

$${I}_{L} = \frac{{V}_{out} \times {I}_{out}}{{V}_{i n} \times η}$$

wherein η is a power conversion efficiency of the power stage circuit 110. On the other hand, in the switching regulator 200 according to the present invention, the inductor current is:

$${I}_{L} = \frac{( {V}_{out} - {V}_{i n 2} ) \times {I}_{out}}{{V}_{i n 1} \times η}$$

Assuming that the input voltage Vin is equal to the input voltage Vin1, the inductor current according to the present invention is relatively lower, i.e., the switching regulator 200 according to the present invention can complete the same voltage conversion as the prior art switching regulator 100 by a relatively lower inductor current.

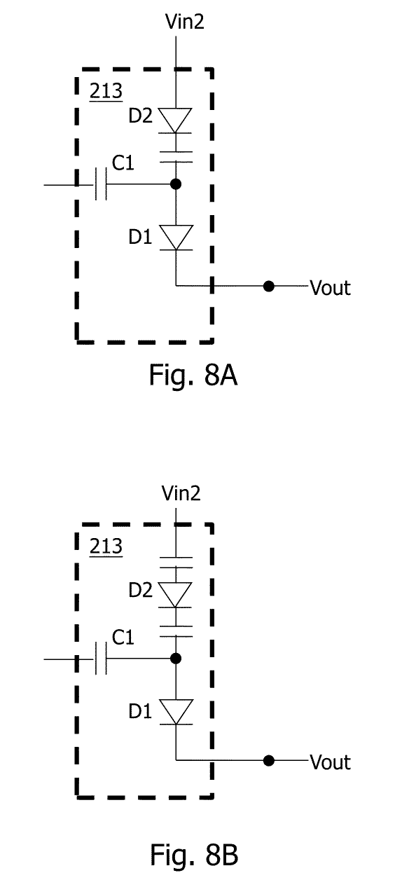

Note that, in the second embodiment, the input voltage Vin1, the predetermined voltage Vin2, and the output voltage Vout may be of different high and low levels. A preferable embodiment is that the predetermined voltage Vin2 is not higher than the input voltage Vin1. Besides, the charge pump is not limited to the circuit shown in the figure. The charge pump may be various forms of charge pumps, such as a double-voltage charge pump circuit, a negative voltage charge pump circuit, etc. For example, FIGS. 8A-8B show other embodiments of the passive circuit.

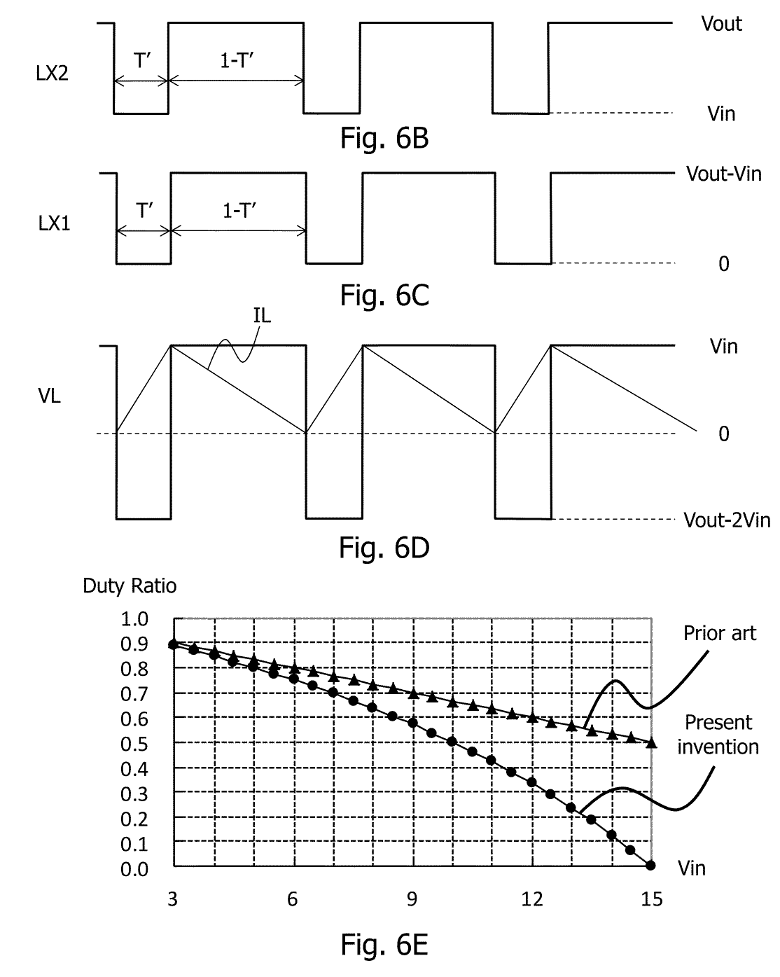

FIG. 5 shows a third embodiment of the present invention. This embodiment shows another more specific structure of a switching regulator 300 according to the present invention. As shown in FIG. 5, the active circuit 311 includes another form of the boost power stage circuit, which has the power switch M1, the inductor L1, and the diode D2; and the passive circuit 213 includes the capacitor C1, and the diodes D1 and D2, wherein the capacitor C1 and the diodes D1 and D2 form the charge pump. The passive circuit 213 receives the predetermined voltage Vin2, wherein the predetermined voltage Vin2 for example is not higher than the input voltage Vin1. Certainly, the predetermined voltage Vin2 may have the same level with the input voltage Vin1.

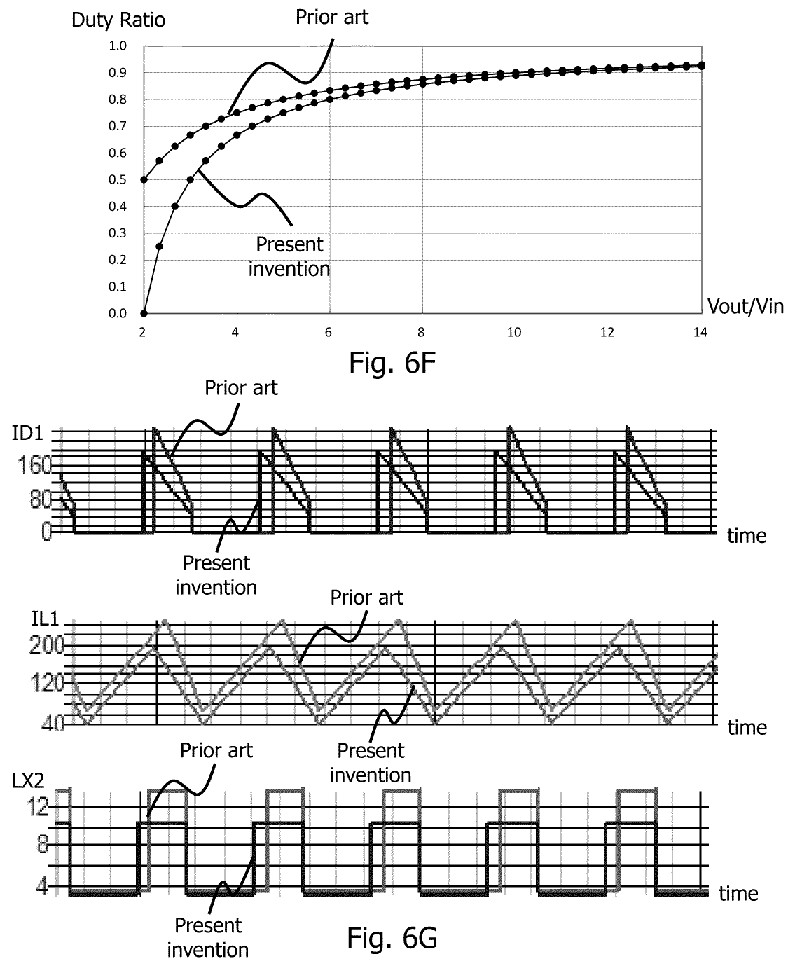

FIGS. 6A-6G show advantages of the present invention over the prior art by illustrative examples. The examples are based on the structure of the aforementioned second embodiment, wherein when the driving signal GATE turns ON the power switch M1, a current I1 flows through the inductor L1, and a current I2 flows through the diode D2 to charge the capacitor C1; a total of the current I1 and the current I2 flows through the power switch M1. When the driving signal GATE turns OFF the power switch M1, the inductor L1 generates a current I3 which flows through the capacitor C1 and the diode D1 to the output terminal Vout.

FIGS. 6B, 6C, and 6D show examples of signal waveforms of the second embodiment according to the present invention. FIGS. 6B and 6C show voltage signal waveforms of nodes LX2 and LX1 respectively; and FIG. 6D shows signal waveforms of a voltage drop VL and a current IL of the inductor L1. T′ is a duty ratio of the power switch M1, which can be obtained by:

$${T}^{′} \times {V}_{i n} = ( 1 - {T}^{′} ) \times ( {V}_{out} - 2 {V}_{i n} )$$

$$( 2 - {T}^{′} ) \times {V}_{i n} = ( 1 - {T}^{′} ) \times {V}_{out}$$

$$1 + \frac{1}{1 - {T}^{′}} = \frac{{V}_{out}}{{V}_{i n}}$$

$${T}^{′} = 1 - \frac{{V}_{i n}}{{V}_{out} - {V}_{i n}}$$

In contrast, the duty ratio T of the prior art switching regulator 100 shown in FIG. 1 is:

$$\frac{1}{1 - T} = \frac{{V}_{out}}{{V}_{i n}}$$

$$T = 1 - \frac{{V}_{i n}}{{V}_{out}}$$

As illustrated by the comparison, for the same conversion, i.e., to convert the same input voltage to the same output voltage, the prior art switching regulator 100 requires a higher duty ratio T higher than the duty ratio T′ of the switching regulator 200 according to the present invention.

FIG. 6E shows a comparison between the prior art and the present invention by characteristic curves of duty ratio versus input voltage Vin under the same output voltage of 30V. As shown in FIG. 6E, to generate the same output voltage, the duty ratio of the prior art is higher than the duty ratio according to the present invention. The figure also illustrates that as the input voltage Vin increases, the duty ratio of the present invention is more lower than the duty ratio required in the prior rt.

FIG. 6F shows a comparison between the prior art and the present invention by characteristic curves of duty ratio versus input/output voltage ratio (Vin/Vout). As shown in FIG. 6F, for the same conversion to convert the same input voltage to the same output voltage, the prior art requires a higher duty ratio higher than the duty ratio of the present invention, which supports the conclusion reached in the above description.

FIG. 6G shows a comparison between the prior art and the present invention with respect to signal waveforms of currents ID1 and IL1, and voltage at the node LX2 under the same output voltage (for example 9.9V). As shown in FIG. 6G, under the same output voltage, the currents ID1 and IL1, and the voltage at the node LX2 of the prior art is obviously higher than the currents ID1 and IL1, and the voltage at the node LX2 according to the present invention.

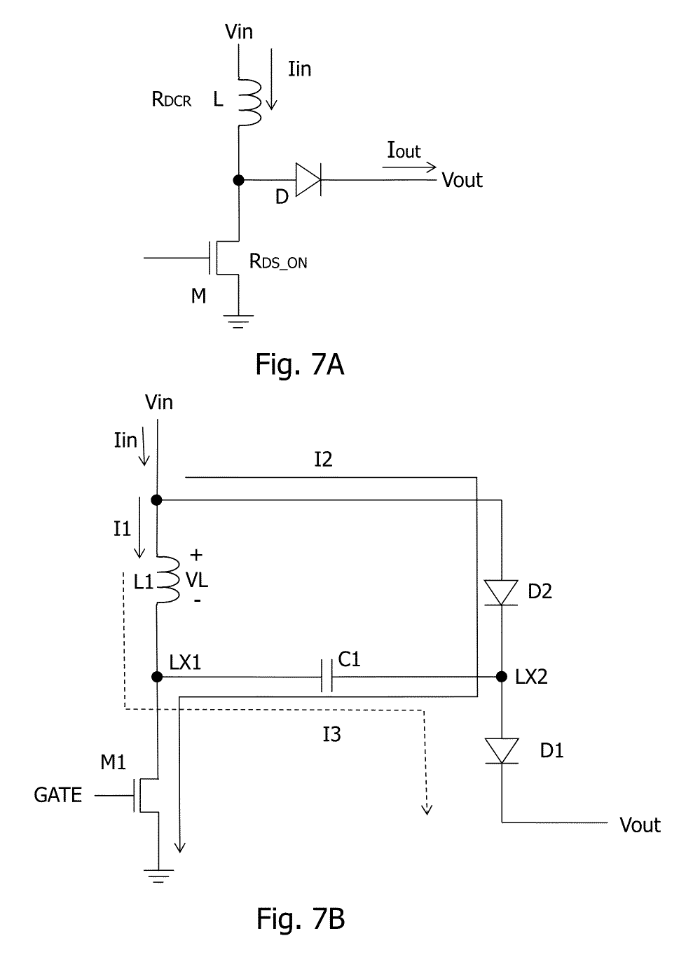

FIGS. 7A-7B show a comparison between the prior art and the present invention with respect to currents and voltages, to compare the conversion loss and switching loss between the prior art and the present invention. The conversion loss and switching loss of the prior art switching can be obtained by:

P_{MOS}=Iᵢₙ²×R_{DS}_{_{—}}_{ON}×T

P_{DCR}=Iᵢₙ²×R_{DCR}×T

P_{SW}=½×Iᵢₙ×Vₒᵤₜ×(tᵣ+t_{f})×f_{sw}

wherein PMOS is the power consumption of the power switch M; Iin is the input current; RDS_{—}ON is the source-drain conduction resistance of the power switch M; T is the duty ratio; PDCR is the powerconsumption of the inductor L; RDCR is the equivalent resistance of the inductor L; PSW is the switching loss of the power switch M; tr is the rising time of the power switch M; tf is the falling time of the power switch M; and fSW is switching frequency of the power switch M. On the other hand, the conversion loss and switching loss of the switching regulator according to the present invention can be obtained by:

P_{MOS}=Iᵢₙ²×R_{DS}_{_{—}}_{ON}×T′

P_{DCR}=I₁²×R_{DCR}×T′

P_{SW}=½×Iᵢₙ×(Vₒᵤₜ−Vᵢₙ)×(tᵣ+t_{f})×f_{sw}

wherein the input current Iin is equal to I1+I2; and T′ is the duty ratio. Under the same condition, i.e., the same output voltage Vout and the same input current Iin, the power consumption and switching loss of the prior art are both higher than the power consumption and switching loss of the present invention; in other words, in comparison with the prior art, the present invention has advantages that the power conversion efficiency is improved, and the power consumption and the switching loss are reduced. From another perspective, with a power switch having the same withstand voltage, the switching regulator according to the present invention can be applied to a higher output voltage Vout compared with the prior art switching regulator. Or, for the same output voltage Vout, the switching regulator according to the present invention can operate with a power switch having a lower withstand voltage compared to the prior art switching regulator.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, a device which does not substantially influence the primary function of a signal can be inserted between any two devices shown to be in direct connection in the embodiments, such as a switch or the like, so the term “couple” should include direct and indirect connections. In view of the foregoing, the spirit of the present invention should cover all such and other modifications and variations, which should be interpreted to fall within the scope of the following claims and their equivalents.

What is claimed is:

1. A switching regulator for converting an input voltage to an output voltage, comprising:
a power stage circuit, for switching at least one power switch thereof according to a driving signal to convert the input voltage to the output voltage, the power stage circuit including:
an active circuit, which includes the power switch and an inductor, the active circuit being controlled by the driving signal to convert the input voltage to a middle voltage; and
a passive circuit, which is coupled to the active circuit, and includes a charge pump for converting the middle voltage to the output voltage, wherein the charge pump consists of one or more passive devices without any active device; and
a control circuit, which is coupled to the power stage circuit, for generating the driving signal according to a feedback signal.

2. The switching regulator of claim 1, wherein the charge pump includes:
a capacitor, which has one end coupled to a node between the power switch and the inductor;
a first diode, which has a first forward terminal coupled to another end of the capacitor, and a first reverse terminal coupled to the output voltage; and
a second diode, which has a second forward terminal for receiving a voltage, and a second reverse terminal coupled to the another end of the capacitor, wherein the voltage is the input voltage or another voltage.

3. The switching regulator of claim 2, wherein the active circuit and the first diode of the charge pump form a boost power conversion circuit.

4. The switching regulator of claim 1, wherein the passive circuit receives a predetermined voltage which is the input voltage or a voltage lower than the input voltage.

5. A switching regulator for converting an input voltage to an output voltage, comprising:
a power stage circuit, for switching at least one power switch thereof according to a driving signal to convert the input voltage to the output voltage, the power stage circuit including:
an active circuit, which includes the power switch, an inductor, and a first diode, the active circuit being controlled by the driving signal to convert the input voltage to a middle voltage, wherein the power switch, the inductor, and the first diode are coupled to a common node; and
a passive circuit, which is coupled to the active circuit, and includes a charge pump for converting the middle voltage to the output voltage, wherein the charge pump and the active circuit share the first diode; and
a control circuit, which is coupled to the power stage circuit, for generating the driving signal according to a feedback signal.

6. The switching regulator of claim 5, wherein the charge pump consists of one or more passive devices without any active device.

7. The switching regulator of claim 5, wherein the charge pump includes:
a capacitor, which has one end coupled to a node between the power switch and the inductor;
the first diode, which has a first forward terminal coupled to another end of the capacitor, and a first reverse terminal coupled to the output voltage; and
a second diode, which has a second forward terminal for receiving a voltage, and a second reverse terminal coupled to the another end of the capacitor, wherein the voltage is the input voltage or another voltage.

8. The switching regulator of claim 5, wherein the active circuit is a boost power conversion circuit.

9. The switching regulator of claim 5, wherein the passive circuit receives a predetermined voltage which is the input voltage or a voltage lower than the input voltage.
